(19) United States
(12) Patent Application Publication
(10) Pub. No.: US 2012/0188182 A1
(43) Pub. Date: Jul. 26, 2012

(54) APPARATUS FOR INTERFACING WITH ELECTRONIC TOUCH-SCREEN DEVICES

(76) Inventor: ANN McKENNA, Calgary (CA)

(21) Appl. No.: 13/347,902

(22) Filed: Jan. 11, 2012

Related U.S. Application Data
(60) Provisional application No. 61/435,108, filed on Jan. 21, 2011.

(51) Int. Cl. G06F 3/041; G06F 3/033

(52) U.S. Cl. 345/173; 345/179

(57) ABSTRACT

The present invention may provide an apparatus to facilitate a user's interaction with a touch screen. The apparatus may include a tubular body with a first end and a second end with a cavity therebetween. The cavity may receive a digit, for example a finger of a user via one end. The second end may include a contact point for transmitting the user's touch to the touch screen.

### FIELD OF ART

The present invention provides an improved apparatus and method of user interfacing with touch screens of electronic devices.

### BACKGROUND

An ever increasing number of electronic devices require a user to directly interact with the device through a touch screen interface. The advantages of touch screen interfaces are well understood and known in the art. For example, a variety of electronic devices including personal devices such as mobile phones, smart phones, video gaming devices, personal digital assistants may include touch screen interfacing. Further, non-personal electronic devices such as point of sale systems, automated teller machines and various information kiosks may also incorporate touch screen interface technology.

A common drawback of touch screens is the unattractive effect of having fingerprints, smudges and other sebaceous or other deposits on the screen being left behind by a user. Further, in the context of non-personal electronic devices that utilize touch screen technology, there may an increased risk of communicable illnesses being passed from one user to another through the touch screen interface.

Various apparatuses and methods for keeping a touch screen interface clear of smudges, oil deposits and fingerprints are known. For example, a cloth may be used to clean off smudges, deposits and fingerprints or solvents may be used with an appropriate cloth to mitigate the transfer of microbiological contaminants; however, these require a cleaning between each user and may not be practical in all instances.

Further, a large percentage of users employ a personal password to “unlock” various personal electronic devices and the password may be entered via a touch screen. In some instances, the repetitive entry of a personal password may leave a greater concentration of smudges, deposits or finger prints in the password relevant regions of the touch screen, thereby possibly creating a security vulnerability by allowing unauthorized-users to view the smudges, deposits and finger prints and more easily determine the authorized user's personal password.

Further, films or covers are known that may be used to cover the touch screen. However, films are most practical for personal electronic devices and ultimately do not prevent the inherent issue of fingerprints and smudges being deposited on the film, thereby ultimately necessitating cleansing with a cloth and the like. As well, the manner by which films adhere to the touch screen may degrade over time necessitating continual replacement, or the film may interfere, even partially, with the electrical properties of the touch interface and performance of the device.

A stylus is also a known application to address some of the aforementioned issues with touch screen interfaces. A variety of the known styluses are shaped and therefore held like pens with a single point of contact with the touch screen; this may preclude or interfere with various multi-touch applications. Further, various U.S. patents to Robb (U.S. Pat. Nos. 6,075,189, 6,225,988 and 6,320,570) teach various styluses that a user may wear on user's finger to enhance user's interaction efficiency with a touch screen interface. The use of such a stylus may interfere with other activities that a user may wish to participate in while using a touch screen, for example searching through pockets of trousers, a suit jacket and handbag and the like, which the stylus may interfere with.

### SUMMARY

The present invention may provide an apparatus to facilitate a user's interaction with a touch screen, the apparatus comprising: at least one tubular body including an open end and a closed end with a cavity therebetween, the cavity to receive at least one finger of a user via the first end; and the second end includes a contact point for indicating or transferring the user's touch to the touch screen.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is a side view of an example embodiment of the present invention for use with a touch screen;

FIG. 2A provides a perspective view of an example embodiment of the present invention;

FIG. 2B provides a cross-sectional view of the example embodiment of FIG. 2A taken through line B-B′;

FIG. 2C provides a cross-sectional view of the example embodiment of FIG. 2A taken through line C-C′;

FIG. 2D provides a side view of the example embodiment of FIG. 2A;

FIG. 2E provides a perspective view of an example embodiment for use on a user's hand.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details. Further, the drawings provided are not necessarily to scale and in some instances proportions may have been exaggerated in order more clearly to depict certain features. Throughout the drawings, from time to time, similar numbers may be used to reference similar, but not necessarily identical, parts.

The present invention may provide an apparatus to facilitate a user's interaction with a touch screen generally denoted as 100 which are commonplace in a variety of electronic devices. The apparatus may include a tubular body 10 with a first end 12 and a second end 14 with a cavity 16 therebetween. The cavity may receive a digit, for example a user's finger via one end of the body. The second end may include a contact point 18 for indicating or transferring the location of the user's touch to the touch screen.

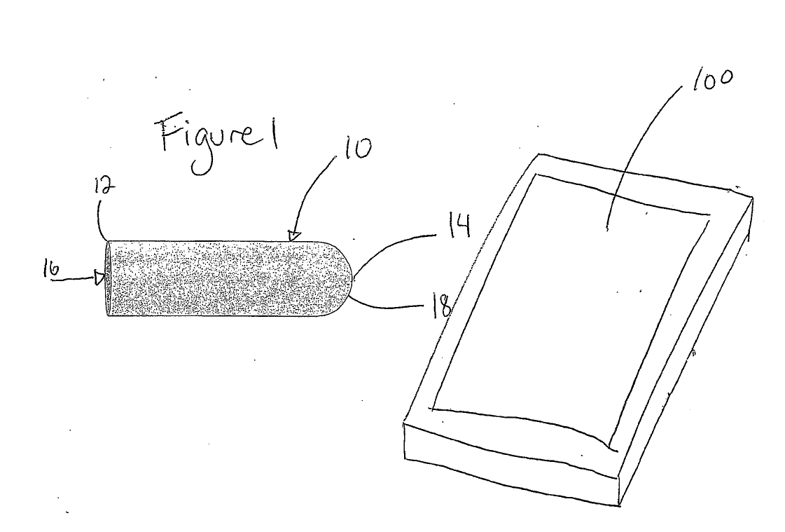

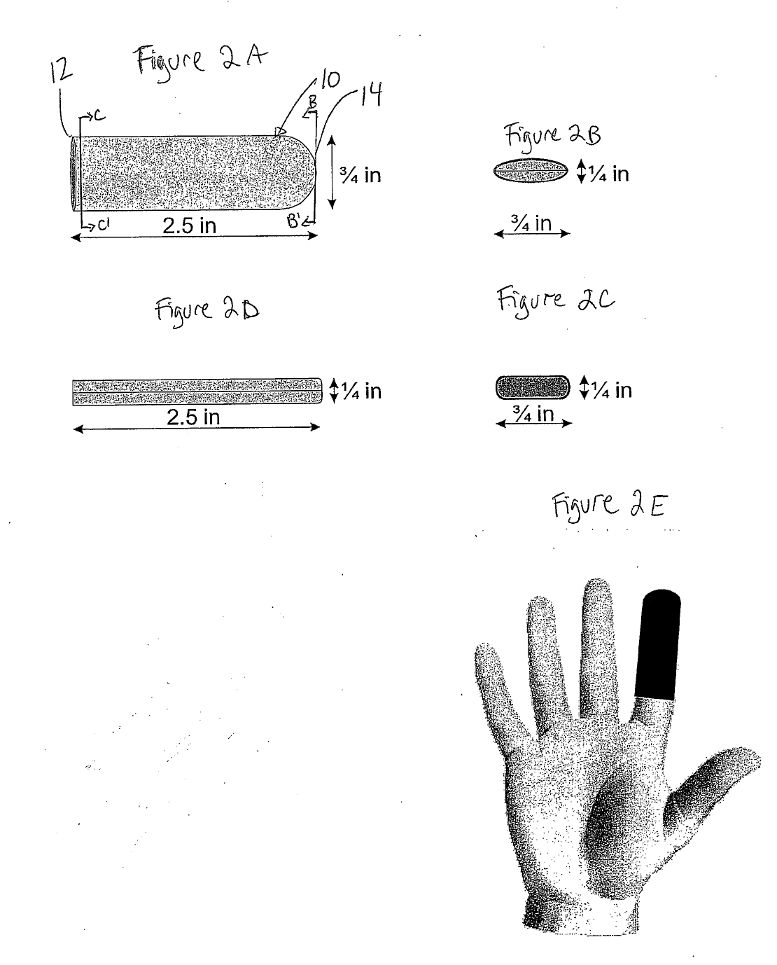

As shown in FIG. 1, an example embodiment of the present invention is depicted. The apparatus includes body 10 which may be tubular in form. The body may have first end 12 and second end 14 and hollow cavity 16 between the two ends. Without restricting the present disclosure to specific dimensions, the cavity may be of a sufficient diameter to accommodate a user's digit, for example a finger, thumb, toe or any other body part with which a user uses to interface with a touch screen. The digit may be inserted into the cavity, from the first end, and the body will extend at least partially along the length of the digit. In one aspect, the cavity may be sized to receive and frictionally retain a user's finger and the body may extend from the tip of the user's finger towards the user's hand, perhaps covering one or more joints of the user's finger.

The second end of the body may include a contact point 18 for interfacing with the touch screen. In one aspect, the contact point may be a small nub or protuberance that is equal to, or of a smaller total surface area than that of the user's finger tip. This dimensional differential may allow the user to more accurately interface with the touch screen. In other words, the smaller surface of the contact point, relative to the size of the surface of the user's finger tip, may allow the user to have finer control over interactions with the touch screen's surface

As an example, the contact point may increase the efficiency of typing on a touch screen “keyboard” interface where the elements of the keyboard are positioned so close together that errant key strokes are common when typing only with the user's finger.

In one aspect, the contact point may be integral in the construction of the body. For example, in construction, the body may be made from one piece of material and it may be folded to produce the tubular body and a stitched hem may be used to hold the tubular form. The material may then be turned inside out so that the stitched hem is on the inner surface of the tubular body. In this aspect, the tube protrusion on its exterior cause by the bulk of material in the stitched hem may form a contact point. In another aspect, the stitched hem may remain on the outer surface of the body and form a contact point that way.

In another aspect, the contact point may be a separate component that is affixed or applied to the second end of the body and the positioning of the contact point will either be in very close indirect or direct contact with the tip of the user's finger.

In another aspect, there may be an aperture located at the second end and the contact point may be secured within the aperture so that the user's finger will make direct contact with the contact point. For example, the contact point may be secured by stitching, adhesives, connectors and the like provided that there is an effective transmission of the position of the user's finger tip to the touch screen via the contact point to ensure touch screen interface accuracy.

In one aspect the entire body of the present invention may be constructed from such suitable conductive materials, as described herein below. In another aspect, only part of the body may be constructed from the suitable conductive materials and other parts of the body may be constructed from other types of materials, for example fashion materials or cleaning materials that are, for example textured, to enable a user to wipe down a touch screen and substantially remove any residue on the touch screen from previous use or previous users. For example, a natural or synthetic chamois material, natural or synthetic suede, a microfiber or any other material that may provide a similar cleaning surface may be used on any surface of the body other than the surface where the user interacts with the touch screen, which may be constructed of suitable conductive materials.

The specific mechanisms by which touch screens identify the location of a user's interaction are well known and varied. For example, there are capacitive-sensitive touch screens that respond to changes in the capacitance in the touch screen, for example, by direct contact with a conducting surface, such as the skin of a user. Further, there are non-capacitive touch screens that respond to any a wide variety of inputs on the surface that is sufficient to create a detectable signal by the electronic device's controller and processing systems, for example, resistive, infrared, surface acoustic wave technologies and the like. Therefore, it may be desirable to construct at least a portion of the present invention to allow for use with both capacitive-sensitive touch screens and non-capacitive touch screens, for example by using suitable conductive materials that permit and provide a conductive surface, and materials that allow for the transmission of sufficient pressure, from the user's finger to the touch screen.

Examples of some suitable materials include, but are not limited to: Bullionet™ Mesh; AL100 Wall Shield; Shieldit™ Super; High Performance Silver Mesh Fabric; ArgenMesh™; Soft&Safe™; RadioScreem™; VeilSheild™, CobalTex™; ESD Static Fabric™; Ex-Static™; Staticot™; Stainless Steel Mesh; Pure Copper Polyester Taffeta; Canop Mesh Fabric; Nickel/copper Ripstop Fabric; Stretch Conductive Fabric all of which are supplied by Less EMF, Inc. of Albany N.Y., U.S.A. Further, the materials MedTex™ P-130 and MedTex™ P180 both supplied by Shieldex U.S. of Palmyra, N.Y., U.S.A. may be applicable.

In another aspect, the contact point, either as an integral component of the body or, as described herein above, as a separate, affixed or applied component or material may be composed entirely of, or partially of a suitable conductive material and the remainder of the body may be made from either fashion materials, cleaning materials or both.

In another aspect the body may be composed entirely of fashion material, cleaning materials or a combination of both. The contact point may include an embroidered pattern of conductive thread that is stitched into the second end of the body. The precise design of the embroidered pattern is not important to the present invention; however, as described herein, it may be desirous to have the surface area of the embroidered pattern to be smaller than the user's finger tip to increase the interface efficiency, for example typing on a closely spaced touch screen keyboard.

In one embodiment, the present invention may be approximately 6.4 cm from the first end to the second end. The tubular body may have an elliptical cross-sectional shape with the longer axis being approximately 1.9 cm width and 0.6 cm in height. However, as one skilled in the art may appreciate the present invention is not limited by specific materials or dimensions.

In one aspect, a plurality of the aforedescribed apparatus may be worn by a user on more than one digit to enable multi-touch interaction with a touch screen. In one aspect, each apparatus of the plurality may be connected to each other by connections, for example straps, cord, string and the like to ensure that each apparatus of the plurality remains connected to the others to prevent loss. These connections may also allow the user to attach the plurality of apparatuses to the electronic device for storage during periods of non-use.

In another aspect, the plurality of apparatuses may be connected. For example by a glove-like member that is worn over at least a part of the user's hand.

In another aspect, a rigid annular ring structure may be attached at the first end of the body. The ring may act as a storage vessel during periods of non-use, in that the user may roll the body up into the ring to prevent damage to the body.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

What is claimed is:

1. An apparatus to facilitate a user's interaction with a touch screen, the apparatus comprising:
(a) at least one tubular body including an open end and a closed end with a cavity therebetween, the cavity to receive at least one finger of a user via the first end; and
(b) the second end includes a contact point for indicating or transferring the location of the user's touch to the touch screen.

2. The apparatus of claim 1 where the contact point contacts both the user's finger and the touch screen.

3. The apparatus of claim 1 where the surface area of the contact point touching the touch screen is smaller than the surface area of the user's finger which would have contacted the touch screen but for the interposition of the apparatus between the finger and the screen.

4. The apparatus of claim 3 where the contact point is embroidered onto the apparatus on a portion of the apparatus meant to contact the touch screen.

5. The apparatus of claim 1 where the material of the contact point is one of Bullionet™ Mesh; AL100 Wall Shield; Shieldit™ Super; High Performance Silver Mesh Fabric; ArgenMesh™; Soft&Safe™; RadioScreem™; VeilSheild™, CobalTex™; ESD Static Fabric™; Ex-Static™; Staticot™; Stainless Steel Mesh; Pure Copper Polyester Taffeta; Canop Mesh Fabric; Nickel/copper Ripstop Fabric; Stretch Conductive Fabric, MedTex™ P-130 and MedTex™ P180 or any suitable material operative with the touch screen.

6. The apparatus of claim 1 where the contact point is an appropriately sized and placed seam in the apparatus' construction.
